(19) United States
(12) Patent Application Publication
(10) Pub. No.: US 2025/0105885 A1
(43) Pub. Date: Mar. 27, 2025

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Yinxiao ZHUO, Beijing (CN); Zhaocheng WANG, Beijing (CN); Jianfei CAO, Beijing (CN)

(73) Assignee: Sony Group Corporation, Tokyo (JP)

(21) Appl. No.: 18/727,698

(22) PCT Filed: Jan. 13, 2023
(86) PCT No.: PCT/CN2023/072047

§ 371 Date: Jul. 10, 2024

(30) Foreign Application Priority Data
Jan. 20, 2022 (CN) 202210066296.1

(51) Int. Cl. H04B 7/0456; H04B 7/06; H04W 4/44

(52) U.S. Cl. CPC H04B 7/0456; H04B 7/0617; H04W 4/44

(57) ABSTRACT

Provided in the present disclosure are an electronic device and method for wireless communication, and a computer-readable storage medium. The electronic device comprises: a processing circuit, which is configured to: determine a sensing beam group, wherein sensing beams in the sensing beam group and a communication beam are selected from the same beam codebook, and the sensing beams are all different from the communication beam; and to send a combined beam, and repeatedly execute the sending to traverse all the sensing beams in the sensing beam group, wherein the combined beam comprises the communication beam and a sensing beam subgroup, and each sensing beam subgroup comprises one or more sensing beams in the sensing beam group.

This application claims the priority to Chinese Patent Application No. 202210066296.1 titled “ELECTRONIC DEVICE AND METHOD FOR WIRELESS COMMUNICATION, AND COMPUTER-READABLE STORAGE MEDIUM”, filed on Jan. 20, 2022 with the China National Intellectual Property Administration (CNIPA), which is incorporated herein by reference in its entirety.

### FIELD

The present disclosure relates to the technical field of wireless communications, and in particular to joint communication and sensing technology. More particularly, the present disclosure relates to an electronic apparatus and a method for wireless communications, and a computer-readable storage medium.

### BACKGROUND

In a scenario of a future mobile communication application, such as the autonomous driving technology, a system is required to have both communication and detection functions. A communication module has many similarities with a detection module (also referred to as a sensing module or a radar module), both of which may share hardware, share a waveform signal, collaboratively implement function and the like, to save hardware resources and spectrum resources overhead, improving communication and detection performance. Therefore, the design of a joint communication and radar system has become a research hotspot, and is one of 6G key technologies.

The joint communication and radar system (JCR system) has high application value in scenarios, such as, a scenario of an Internet of Vehicles. The joint communication and radar design uses one set of hardware devices of a transmitter, in order to save costs. Therefore, a signal is required to be appropriately designed to ensure that both the communication module and the detection module operate normally.

In the scenario of the Internet of Vehicles, a communication link is required to be established between the communication module and a remote receiver, such as another vehicle or a base station in the distance for data transmission. The detection module is required to perform detection, for example, of distances, locations, or velocity on an object such as vehicles or pedestrians in a short-range and medium-range distance (usually within a range of tens to hundreds of meters), that is, a function of short range radar/medium range radar (SRR/MRR) is required.

In the conventional designs, it is difficult for the detection module to collaborate with the communication module, and a radar detection signal may interfere with communication, causing deterioration of communication performance. Therefore, a new joint communication and radar system is required to reduce interferences and improve communication performance.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry configured to: determine a sensing beam set, wherein, each sensing beam within the sensing beam set is selected from among the same beam codebook as a communication beam and the sensing beams are all different from the communication beam; and transmit a combined beam and repeat the transmitting to traverse all sensing beams within the sensing beam set, wherein, the combined beam comprises the communication beam and a sensing beam subset, and each sensing beam subset comprises one or more sensing beams within the sensing beam set respectively.

According to an aspect of the present disclosure, a method for wireless communications is provided. The method includes: determining a sensing beam set, wherein, each sensing beam within the sensing beam set is selected from among the same beam codebook as a communication beam and the sensing beams are all different from the communication beam; and transmitting a combined beam and repeating the transmitting to traverse all sensing beams within the sensing beam set, wherein, the combined beam comprises the communication beam and a sensing beam subset, and each sensing beam subset comprises one or more sensing beams within the sensing beam set respectively.

According to another aspect of the present disclosure, an electronic apparatus for wireless communications is provided. The electronic apparatus includes processing circuitry configured to: receive, from a communication transmitting terminal, a combined beam which comprises a communication beam and a sensing beam subset, wherein each sensing beam subset comprises one or more sensing beams within a sensing beam set respectively, each sensing beam within the sensing beam set is selected from among the same beam codebook as the communication beam and the sensing beams are all different from the communication beam; and repeat the receiving until all sensing beams within the sensing beam set are traversed.

According to another aspect of the present disclosure, a method for wireless communications is provided. The method includes: receiving, from a communication transmitting terminal, a combined beam which comprises a communication beam and a sensing beam subset, wherein each sensing beam subset comprises one or more sensing beams within a sensing beam set respectively, each sensing beam within the sensing beam set is selected from among the same beam codebook as the communication beam and the sensing beams are all different from the communication beam; and repeating the receiving until all sensing beams within the sensing beam set are traversed.

According to other aspects of the present disclosure, computer program codes and a computer program product for implementing the methods for wireless communications described above, and a computer-readable storage medium recording the computer program codes for implementing the methods for wireless communications described above are further provided.

With the electronic apparatus and the method according to the present disclosure, narrow beams that are different from and transmitted together with the communication beam are used as the sensing beams for sensing, so that the interferences of the sensing beams on the communication beam can be reduced while achieving the coverage of a sensing range, thereby improving communication performance.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 is a block diagram showing functional modules of an electronic apparatus for wireless communications according to an embodiment of the present disclosure;

FIG. 2 shows an example of a multipath channel;

FIG. 3 shows an example of transmission of a combined beam;

FIG. 4 shows another example of transmission of a combined beam;

FIG. 5 shows an example of transmission of a combined beam by using a spreading sequence;

FIG. 6 shows a graph of comparison in communication performance;

FIG. 7 shows a normalized radar phase diagram;

FIG. 8 is a block diagram showing functional modules of an electronic apparatus for wireless communications according to another embodiment of the present disclosure;

FIG. 9 is a flow chart of a method for wireless communications according to an embodiment of the present disclosure;

FIG. 10 is a flow chart of a method for wireless communications according to another embodiment of the present disclosure;

FIG. 11 is a block diagram showing a first example of an exemplary configuration of an eNB or gNB to which the technology of the present disclosure may be applied;

FIG. 12 is a block diagram showing a second example of an exemplary configuration of an eNB or gNB to which the technology of the present disclosure may be applied;

FIG. 13 is a block diagram showing an example of an exemplary configuration of a smartphone to which the technology according to the present disclosure may be applied;

FIG. 14 is a block diagram showing an example of an exemplary configuration of a car navigation apparatus to which the technology according to the present disclosure may be applied; and

FIG. 15 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

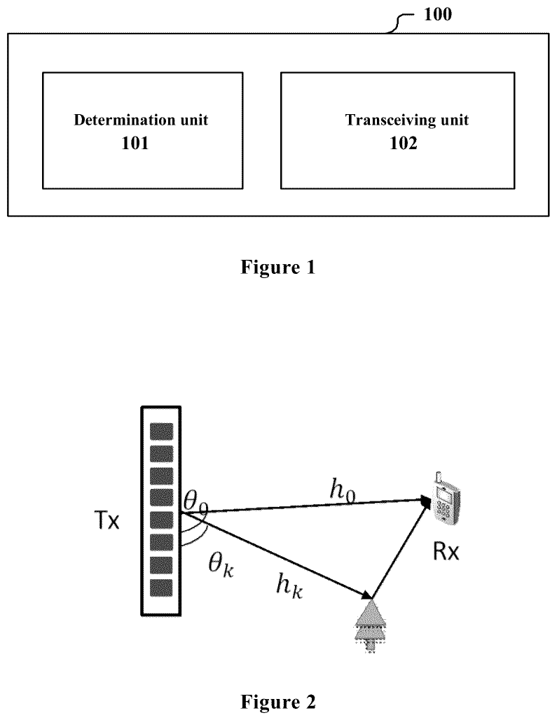

FIG. 1 shows a block diagram of functional modules of an electronic apparatus 100 according to an embodiment of the present disclosure. As shown in FIG. 1, the electronic apparatus 100 includes a determination unit 101 and a transceiving unit 102. The determination unit 101 is configured to determine a sensing beam set, where, each sensing beam within the sensing beam set is selected from among the same beam codebook as a communication beam and the sensing beams are all different from the communication beam. The transceiving unit 102 is configured to transmit a combined beam and repeat the transmitting to traverse all sensing beams within the sensing beam set, wherein, the combined beam includes the communication beam and a sensing beam subset, and each sensing beam subset includes one or more sensing beams within the sensing beam set respectively.

The determination unit 101 and the transceiving unit 102 may be implemented by one or more processing circuitries, and the processing circuitry may be implemented as, for example, a chip or a processor. Moreover, it should be understood that various functional units in the electronic apparatus shown in FIG. 1 are only logical modules divided based on specific functions implemented by these functional units, and are not intended to limit a specific implementation.

The electronic apparatus 100 may be, for example, provided at a UE side, or may be communicatively connected to UE. For example, in a scenario of an Internet of Vehicles, the electronic apparatus 100 may be provided at a vehicle side. In addition, the electronic apparatus 100 may be provided at a base station side or a roadside unit (RSU). The scenarios where the present disclosure may be applied are not limited to the Internet of Vehicles. The present disclosure may be applied to any scenario that requires the joint communication and sensing technology.

Here, it should be further noted that the electronic apparatus 100 may be implemented in a chip level or an apparatus level. For example, the electronic apparatus 100 may operate as the UE or a base station itself, and may further include an external device such as a memory and a transceiver (not shown in FIG. 1). The memory may be configured to store programs to be executed by the UE or the base station to implement various functions and related data information. The transceiver may include one or more communication interfaces to support communications with different apparatus (for example, another base station, and another UE). The implementation of the transceiver is not limited herein.

As described above, in the JCR system, it is required to jointly design the communication module and the detection module to achieve both communication and detection functions. In the following descriptions, the scenario of the Internet of Vehicles is taken as an example for ease of understanding. However, it should be understood that this is not restrictive.

In order to save hardware resources, it is assumed that the communication module and the detection module share a hardware device of a transmitting terminal (referred to as a communication transmitting terminal), a transmitting signal is used for both communication and radar detection, a communication receiving terminal receives a communication signal, and a radar receiving terminal receives an echo for detection. The communication receiving terminal is located at a remote end (such as another vehicle or a base station), and the radar receiving terminal is provided adjacent to the communication transmitting terminal. It can be approximately considered that a transmitter of the transmitting terminal has the same location of antenna as a radar receiver. It is assumed that the transmitter of the transmitting terminal is sufficiently isolated from the radar receiver to eliminate self-interference. Furthermore, it is assumed that a channel is a millimeter-wave multipath channel. The electronic apparatus 100 according to the embodiment is provided, for example, at the communication transmitting terminal or communicatively connected to the communication transmitting terminal.

Hereinafter, models of a communication receiving signal and a radar receiving signal are described.

FIG. 2 shows an example of a multipath channel, where Tx represents a transmitter and Rx represents a receiver. Assuming that the transmitter is a half-wavelength uniform linear array (ULA), the number of antennas is N_{T}, the receiver is a single antenna, a channel from the transmitter to the receiver is denoted as h (where h represents an N_{T}×1-dimensional vector), and includes a Line of Sight (LoS) path h₀ (where h₀ represents an N_{T}×1-dimensional vector) and P Non Line of Sight (NLoS) paths hₖ (where hₖ represents an N_{T}×1-dimensional vector), k=1, . . . , P. Assuming that an attenuation factor of the path hₖ is γₖ, k=0, 1, . . . , P (where γₖ represents a complex number), the multipath channel h may be expressed by the following equation (1).

$$h = {\sum }_{k = 0}^{P} {γ}_{k} {h}_{k} \qquad ( 1 )$$

Assuming that an angle of departure (AoD) of a k-th path is θₖ^{(AoD)}, the k-th path may be expressed as:

$${h}_{k} = a ( {N}_{T} , {θ}_{k}^{( AoD )} ) , k = 0 , 1 , … , P \qquad ( 2 )$$

Where,

$$a ( N , θ ) = {\frac{1}{\sqrt{N}} [ 1 , {e}^{- j π cos θ} , {e}^{- 2 j π cos θ} , … , {e}^{- ( N - 1 ) j π cos θ} ]}^{T}$$

represents a steering vector of N antennas at an angular direction θ.

Single stream transmission is taken as an example. A transmission symbol of the base station is s (where s represents a complex number), a transmission steering vector f (where f represents an N_{T}×1-dimensional vector) is used, a transmission power is β, additive noise of the receiving terminal is n (where n represents a complex number), and then a signal y (where y represents a complex number) received by the receiving terminal may be written by the following equation (3):

$$y = \sqrt{β} {h}^{H} fs + n \qquad ( 3 )$$

Where, the superscript H represents a conjugate transpose operation. If q=h^{H}f, |q|² represents a beamforming gain. In general, the greater the beamforming gain is, the higher the signal-to-noise ratio of the receiving terminal is and the better the communication quality is.

For the detection module in the JCR system, for example, it may be considered to use an OFDM radar compatible with communication, that is, a distance and velocity of an object is detected using an OFDM signal. Assuming that a coherent processing interval includes N_{sym} OFDM symbols, one OFDM symbol with a duration of T_{OFDM} includes N_{c} subcarrier signals, a subcarrier spacing is Δf, in a transmitted μ-th OFDM symbol, a signal transmitted on an n-th subcarrier is s[μ, n], where μ=0, 1, . . . , N_{sym}−1, n=0, 1, . . . , N_{c}−1. Similarly, assuming that the number of antennas of the transmitter is N_{T}, a transmitting steering vector f (where f represents an N_{T}×1-dimensional vector) is used, and the receiver uses an omnidirectional single antenna for reception. Assuming that there are K target objects in an environment, a round-trip delay of a signal of each of the target objects is within a cyclic prefix. A channel between the transmitter and a k-th target object is hₖ (where hₖ represents an N_{T}×1-dimensional vector), an attenuation and reflection coefficient is Aₖ (where, Aₖ represents a complex number), a distance of the target object is Rₖ, a Doppler frequency shift is f_{D,k}, and the radar receiver receives an echo yₖ [μ, n] of the OFDM signal after being reflected by the target object. The echo yₖ [μ, n] may be expressed by the following equation (4):

$${y}_{k} [ μ , n ] = {A}_{k} exp ( - j 2 π n Δ f \frac{2 {R}_{k}}{{c}_{0}} ) exp ( j 2 π μ {T}_{OFDM} {f}_{D , k} ) {h}_{k}^{H} f s [ μ , n ] \qquad ( 4 )$$

Where, the Doppler frequency shift is

$${f}_{D , k} = \frac{2 {v}_{r e l} {f}_{c}}{{c}_{0}} ,$$

vᵣₑₗ represents a radial relative movement velocity between the radar (i.e., the communication transmitting terminal and the communication receiving terminal) and the target object, f_{c} represents a carrier frequency, c₀ represents a velocity of light. Echo signals reflected by all target objects in the environment are superimposed to form a final receiving signal of the radar receiver:

$$y [ μ , n ] = {\sum }_{k = 1}^{K} {y}_{k} [ μ , n ] = {\sum }_{k = 1}^{K} {A}_{k} exp ( - j 2 π n Δ f \frac{2 {R}_{k}}{{c}_{0}} ) exp ( j 2 π μ {T}_{OFDM} {f}_{D , k} ) {h}_{k}^{H} fs [ μ , n ] \qquad ( 5 )$$

Mesh division and related processing are performed on range-Doppler frequency shift parameters, to obtain a range-Doppler phase diagram for the radar detection. It can be seen that hₖ^{H}f represents a detection gain brought by beams of the transmitting terminal. A greater detection gain indicates that it is easier to distinguish the object on the phase diagram. The phase diagram can be expressed by the following equation:

$$G ( R , {f}_{D} ) = {\sum }_{μ = 0}^{{N}_{sym} - 1} {\sum }_{n = 0}^{{N}_{c} - 1} y [ μ , n ] conj ( s [ μ , n ] ) exp ( j 2 π n Δ f \frac{2 R}{{c}_{0}} ) exp ( - j 2 π μ {T}_{OFDM} {f}_{D} ) \qquad ( 6 )$$

where, conj(s[μ, n]) is the conjugate of s[μ, n].

For a joint communication and radar model, an echo of the communication signal may be directly used for radar detection. The communication beam has high directionality. Therefore, it is difficult to detect an object that is not in a direction of the communication beam due to a very small beam detection gain. Only objects in the direction of the communication beam can be detected through the echo of the communication signal, but the communication beam cannot cover an entire detection angle range.

In view of this, in the embodiment of the present disclosure, the transmitter additionally transmits a signal (referred to as a sensing signal) capable of covering other directions to assist in the detection, and a beam carrying the sensing signal is referred to as the sensing beam in the present disclosure. Considering a long communication distance and a short detection distance, higher power may be allocated to the communication beam and lower power may be allocated to the sensing beam, in order to prevent the sensing signal from submerging the communication signal.

Most sensing beams have very low beam gain for a communication channel, and thus the communication receiving terminal cannot receive the transmitted sensing signal. In a case of serious multipath effect, the sensing signal may enter the receiving terminal through a strong path, which causes strong interferences and leads to a serious decline in communication quality. In the embodiment, the problem is solved by causing the additionally transmitted sensing beam to avoid the communication beam.

Specifically, the determination unit 101 determines a beam in the beam codebook other than the communication beam as the sensing beam. All the sensing beams are referred to as the sensing beam set. For example, the communication beam and the sensing beams within the sensing beam set may basically cover the entire detection angle range. The sensing beam set may include the beams in the beam codebook other than the communication beam. For example, in a case that the communication beam to be used is determined at the communication transmitting terminal and the communication receiving terminal through a beam management process, the determination unit 101 determines the beams in the beam codebook other than the communication beam as the sensing beams within the sensing beam set.

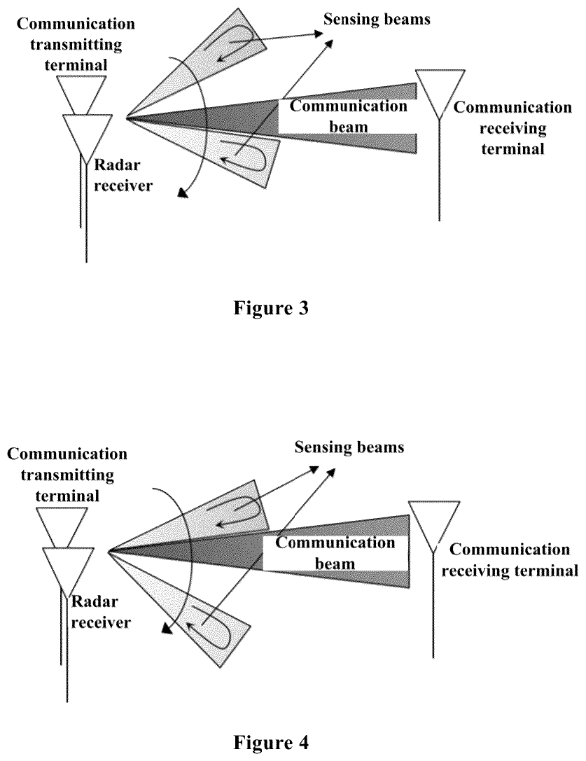

The transceiving unit 102 simultaneously transmits the communication beam and one or more sensing beams within the sensing beam set. In the embodiment, one or more sensing beams transmitted simultaneously are referred to as a sensing beam subset, and the communication beam and the sensing beam subset that are simultaneously transmitted are referred to as a combined beam. FIG. 3 shows an example of transmission of a combined beam. In the example shown in FIG. 3, the combined beam includes the communication beam and two sensing beams, and the sensing beams are different from the communication beam in directivity.

The number of beams that the communication transmitting terminal is capable of simultaneously forming is limited. Therefore, the sensing beams within the sensing beam set are required to be grouped into multiple sensing beam subsets for transmission of multiple times. The number of the sensing beam subsets depends on a ratio of the number of the sensing beams within the sensing beam set to the number of beams that the communication transmitting terminal is capable of simultaneously forming. For example, assuming that the beam codebook uses N_{T}-order Discrete Fourier Transform (DFT) codebook, that is, the communication transmitting terminal has N_{T} candidate beams f₁, . . . , f_{N}_{_{T}}, where

$${f}_{i} = a ( {N}_{T} , arccos ( \frac{2 i - 1 - {N}_{T}}{{N}_{T}} ) ) ,$$

i=1, . . . , N_{T}. A beam used in a communication link is denoted as f_{c}, (N_{T}−1) remaining beams are sensing beams, and are denoted as {f_{s,1}, f_{s,2}, . . . , f_{s,N}_{_{T}}₋₁} sequentially. In a case that the communication transmitting terminal is capable of simultaneously forming N(N≥2) beams, the (N_{T}−1) beams are grouped into

$$G = ⌈ \frac{{N}_{T} - 1}{N - 1} ⌉$$

sensing beam subsets, where ┌ ┐ represents rounding up.

None of the sensing beam subsets overlap with each other, and a collection of the sensing beam subsets forms the sensing beam set. For example, in the above example, for a g(1≤g≤G)-th sensing beam subset, sequence numbers of beams in the g(1≤g≤G)-th sensing beam subset may be expressed as {g, G+g, 2G+g, . . . K_{g}G+g}, where K_{g} represents a maximum non-negative integer to implement K_{g} G+g<N_{T}. It should be understood that the number and a division rule of the sensing beam subsets are not limited to the above, but the sensing beam subsets may be flexibly divided according to actual needs.

FIG. 4 shows another example of transmission of a combined beam, in which sensing beams in the combined beam are different from that in the combined beam shown in FIG. 3. FIG. 3 and FIG. 4 illustrate the transmission of the combined beam on different time-frequency resource elements (RE) respectively, both of which illustrate schematic examples of scanning of the combined beam together. That is, the transceiving unit 102 transmits the combined beam corresponding to each sensing beam subset in multiple REs sequentially. An order in which the transceiving unit 102 transmits the combined beam may be set according to a predetermined rule. For example, the order may be set in accordance with an order of sequence numbers of the sensing beams in the sensing beam subset corresponding to the combined beam, and the like.

Therefore, the transceiving unit 102 repeatedly transmits the combined beam corresponding to each sensing beam subset to traverse all sensing beams within the sensing beam set, thereby covering the entire detection angle range.

In order to make the communication receiving terminal and the radar receiving terminal distinguish different sensing beams, the transceiving unit 102 may be configured to cause different sensing beams to carry different spreading sequence signals. In addition, sensing beams that are adjacent in angle may carry spreading sequence signals with low cross-correlation, in order to improve discrimination. For example, in a case that the spreading sequence signal has a length L, the transmission of each sensing beam subset requires L REs. In the above example, for the g(1≤g≤G)-th sensing beam subset, the spreading sequence signal may be transmitted on the REs with sequence numbers {g, G+g, 2G+g, . . . (L−1)G+g}. Correspondingly, the transceiving unit 102 is configured to traverse all sensing beams within the sensing beam set on LG REs.

Assuming that the communication beam on a certain RE is f_{c} and carries a communication signal s_{c,j}, N sensing beams f_{s,1}, f_{s,2} . . . , f_{s,N} are simultaneously transmitted, a spreading sequence has a length L, the spreading sequence carried on the sensing beam f_{s,i} (i=1, . . . , N) is sᵢ=[s_{i,2}, s_{i,2}, . . . , s_{i,L}], the sensing signal carried on the RE is s_{i,j}, and then a superimposed signal transmitted on the RE is expressed as:

$$\begin{matrix}{x}_{j} = \sqrt{δ} {f}_{c} {s}_{c , j} + {\sum }_{i = 1}^{N} \frac{\sqrt{1 - δ}}{N} {f}_{s , i} {s}_{i , j} & j = 1 , … , L .\end{matrix} \qquad ( 7 )$$

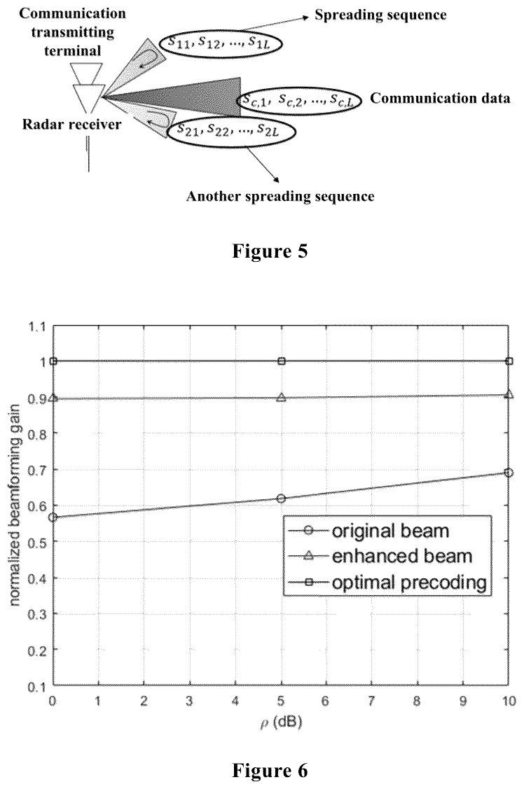

Here, δ represents a power allocation factor, that is, power allocated to the communication beam, and the remaining power is evenly distributed among the N sensing beams simultaneously transmitted. FIG. 5 shows an example of transmission of a combined beam by using a spreading sequence. The transceiving unit 102 may provide a correspondence between respective beams and the spreading sequence signals to the communication receiving terminal in advance through predetermined signaling. For example, it may be agreed that a ZC sequence is used, and the transceiving unit 102 may inform the communication receiving terminal of the length L of the spreading sequence and transmit a radical exponent u_i of a ZC sequence corresponding to each codebook beam in the beam codebook in sequence. Alternatively, it may be agreed that a ZC sequence is used, and the radical exponents corresponding to different beams are offset at equal interval. The transceiving unit 102 informs the communication receiving terminal of the length L of the spreading sequence, an interval d of the radical exponents, and an initial radical exponent of u. The communication receiving terminal may determine the radical exponents of the ZC sequence corresponding to each codebook beam in the beam codebook as {u,u+d,u+2d, . . . } in sequence. In this way, the communication receiving terminal may identify different sensing beams through the spreading sequence.

A signal received by the communication receiving terminal through a channel h is expressed by the following equation:

$$\begin{matrix}{r}_{j} = {h}^{H} {x}_{j} = \sqrt{δ} {q}_{c} {s}_{c , j} + {\sum }_{i = 1}^{N} \frac{\sqrt{1 - δ}}{N} {q}_{s , i} {s}_{i , j} & j = 1 , … , L .\end{matrix} \qquad ( 8 )$$

Here, the first item represents the communication signal received by the communication receiving terminal, and the second item represents the sensing signal (which belongs to interferences with respect to the communication) received by the communication receiving terminal, where q_{c}=h^{H}f_{c} represents a communication beam gain, q_{s,i}=h^{H}f_{s,i} represents a sensing beam gain.

It can be understood that in a case that the communication receiving terminal receives a strong sensing signal, the sensing signal may cause significant interferences and have an adverse effect on the communication. In the embodiment, the communication receiving terminal may inform the communication transmitting terminal of sensing beams causing significant interferences to the communication. The communication transmitting terminal adjusts the communication beam and the sensing beam set based on this information, to reduce or eliminate the interferences caused by the sensing beams, thereby achieving communication enhancement.

In the present disclosure, a sensing beam causing significant interferences to the communication is referred to as an interference sensing beam. The interference sensing beam is determined by the communication receiving terminal based on receiving of the combined beam. The transceiving unit 102 is configured to acquire, from the communication receiving terminal, information regarding interference sensing beams. The determination unit 101 is configured to adjust the communication beam and sensing beam set based on the information of the interference sensing beams.

For example, an interference sensing beam may be a sensing beam with a beam gain above a predetermined threshold determined by the communication receiving terminal.

The parameters in the above example are still used. In a case of using the N_{T}-order DFT codebook, the communication receiving terminal may estimate a beam gain after measuring M (M≥N_{T}) receiving signals. In this case, based on the equation (8), the signal received by the communication receiving terminal is expressed in a matrix form by the following equation (9)

$$r = [ \frac{\sqrt{1 - δ}}{N} {S}^{T} , \sqrt{δ} {s}_{c} ] [ \begin{matrix}q \\ {q}_{c}\end{matrix} ] + n \qquad ( 9 )$$

where, r=[r₁, r₂ . . . , r_{M}]^{T} represents measured M signals, S=(s_{i,j})_{N×M} represents the sensing signal carried on the N sensing beams, s_{c}=[s_{c,1}, s_{c,2}, . . . , s_{c,M}]^{T} represents the communication signal carried on the communication beam, q=[q_{s,1}, q_{s,2}, . . . , q_{s,N}]^{T} represents sensing beam gains of the N sensing beams, and n represents additive noise of the communication receiving terminal.

For example, the communication receiving terminal may estimate a beam gain of the communication beam and beam gains of the sensing beams by using least squares estimation or minimum mean square error (MMSE) estimation, as shown in the following equation (10).

$${[ \begin{matrix}\hat{q} \\ {\hat{q}}_{c}\end{matrix} ] [ \frac{\sqrt{1 - δ}}{N} {S}^{T} , \sqrt{δ} {s}_{c} ]}^{†} r \qquad ( 10 )$$

where, † represents a pseudo-inverse operation of a matrix, \hat{q}=[\hat{q}_{s,1}, \hat{q}_{s,2}, . . . , \hat{q}_{s,N}]^{T}. The communication receiving terminal may select a sensing beam with a large beam gain as the interference sensing beam after estimating the beam gains of all sensing beams.

For example, the communication receiving terminal determines the interference sensing beam based on a relative beam gain relative to the communication beam gain.

For example, the relative beam gain of the sensing beam is defined as a ratio of the beam gain of the sensing beam to the communication beam gain. In the above example, a relative beam gain of the sensing beam f_{s,i} is expressed as:

$$\begin{matrix}{\tilde{q}}_{s , i} = \frac{{\hat{q}}_{s , i}}{{\hat{q}}_{c}} & i = 1 , 2 , … , N .\end{matrix} \qquad ( 11 )$$

For example, the communication receiving terminal may determine a sensing beam with a relative beam gain above the predetermined threshold as the interference sensing beam. For example, in a case that |\tilde{q}_{s,i}|>qₜₕ, the sensing beam f_{s,i} is determined as the interference sensing beam.

The information of the interference sensing beams acquired by the transceiving unit 102 from the communication receiving terminal may include beam indexes of one or more interference sensing beams. In addition, the information of the interference sensing beams may further include one or more of: the number of the interference sensing beams, and information of a beam gain of each of the interference sensing beams. The beam gain herein may be an absolute beam gain (\hat{q}_{s,i}) or the relative beam gain (\tilde{q}_{s,i}). In addition, the number of the interference sensing beams reported by the communication receiving terminal may be predetermined in advance.

For example, when detecting multiple interference sensing beams, the communication receiving terminal may provide feedback to the communication transmitting terminal in a descending order of beam gains of the multiple interference sensing beams. In addition, the communication receiving terminal is not required to provide feedback to the communication transmitting terminal when detecting no interference sensing beam.

In a case that the interference sensing beams include the beam f_{s,i}, it indicates that when the sensing signal is transmitted using the beam f_{s,i}, the sensing signal may cause significant interferences to communication. Therefore, some adjustments may be required to be made by the communication transmitting terminal. For example, the determination unit 101 may be configured to perform the following adjustments: removing at least a part of the interference sensing beams from the sensing beam set, and adding the at least a part of the interference sensing beams to the communication beam. The transceiving unit 102 transmits the combined beam using the adjusted communication beam and sensing beam set. In other words, the communication transmitting terminal changes a part or all of the interference sensing beams into the communication beam to improve the communication beam gain. Therefore, the new communication beam includes the original communication beam and one or more interference sensing beams, and the one or more interference sensing beams are used to enhance the original communication beam.

Assuming that a set of the interference sensing beams for enhancement is {fₛ⁽¹⁾, fₛ⁽²⁾, . . . , fₛ^{(K)}} (note that not all the interference sensing beams may be used, i.e., K may be less than the number of the interference sensing beams fed back by the communication receiving terminal), and relative beam gains corresponding to the interference sensing beams are {\tilde{q}ₛ⁽¹⁾, \tilde{q}ₛ⁽²⁾, . . . , \tilde{q}ₛ^{(K)}}, under a constraint of a constant power, the enhanced new communication beam with the highest gain is expressed as:

$${f}_{c , n e w} = β ( {f}_{c} + {\sum }_{k = 1}^{K} conj ( {\tilde{q}}_{s}^{( k )} ) {f}_{s}^{( k )} ) \qquad ( 12 )$$

where,

$$β = \frac{1}{\sqrt{1 + {\sum }_{k = 1}^{K} {\vert {\tilde{q}}_{s}^{( k )} \vert}^{2}}}$$

represents a normalization factor, conj(\tilde{q}ₛ^{(k)}) is a conjugate of \tilde{q}ₛ^{(k)}. The gain of the new communication beam is expressed as:

$${q}_{c , n e w} = {q}_{c} \sqrt{1 + {\sum }_{k = 1}^{K} {\vert {\tilde{q}}_{s}^{( k )} \vert}^{2}} \qquad ( 13 )$$

Note that the adjusted communication beam covers some beam directions, and the sensing beam covers other directions. Therefore, the sensing range can cover an entire angular domain, and the sensing performance is basically not affected.

For ease of understanding, a comparison of simulation results of the performance of the JCR system using the communication beam enhancing in the embodiment and the performance of the conventional JCR system without the communication beam enhancing is given below.

FIG. 6 shows a graph of comparison in communication performance. A horizontal axis

$$ρ = \frac{{\vert {γ}_{0} \vert}^{2}}{{\vert {γ}_{k} \vert}^{2}} , k = 1 ,$$

L represents an attenuation power ratio of the LoS path to the NLoS path. A smaller ρ indicates that the effect of the NLoS path is greater, and the multipath effect is more serious. A vertical axis represents an average normalized beamforming gain, which indicates that an optimal pre-coding gain is normalized to 1. The communication beam gain obtained from the solution according to the embodiment of the present disclosure and the communication beam gain obtained from the conventional solution are compared with the optimal pre-coding gain. A ratio closer to 1 indicates that the beamforming performance is better.

In the simulation, the number of the antennas of the communication transmitting terminal is set to N_{T}=16, a signal-to-noise ratio is set to 5 dB, and the number of the NLoS paths is 3. The spreading sequence of the sensing signal has the length L=64, and the number of sensing beams transmitted simultaneously is N=2. In FIG. 6, the original beam represents a communication beam gain before the communication beam is enhanced, and the enhanced beam represents a communication beam gain after the communication beam is enhanced, and the optimal pre-coding represents an optimal coding gain, which is normalized to 1. From FIG. 6, it can be seen that the communication beam gain of the enhanced communication beam is significantly higher than the communication beam gain before the communication beam is enhanced, and the enhanced communication beam may achieve about 90% of the optimal beam gain under different multipath scenarios, which proves that according to the solution in the embodiment, communication performance can be significantly improved and strong robustness in multipath scenarios can be achieved.

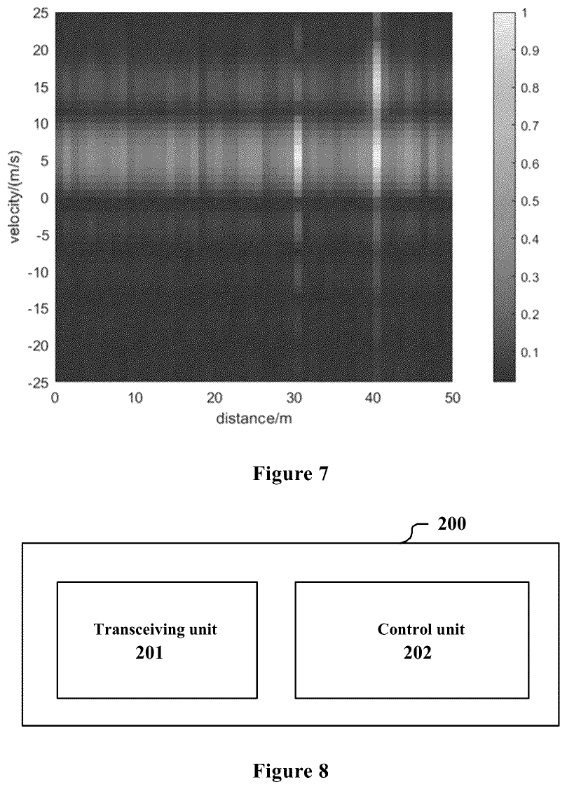

FIG. 7 shows a normalized radar phase diagram, where the horizontal axis represents a distance and the vertical axis represents a velocity. In the simulation, parameters are set as follows: 64 OFDM symbol, 256 subcarriers, a carrier frequency f_{c}=24 GHz, a subcarrier spacing Δf=90.9 kHz, an OFDM symbol length T_{OFDM}=12.375 μs, and a signal-to-noise ratio of the radar receiving terminal is set to 0 dB. Three target objects are arranged within a detection range, distances and velocities of the three target objects are (30 m, 5 m/s), (40 m, 5 m/s), and (40 m, 15 m/s), respectively. The three target objects may be clearly seen from the radar phase diagram in FIG. 7, thus verifying the effectiveness of a sensing module in the JCR system according to the solution of the embodiment.

It should be understood that the above simulation examples are only illustrative rather than restrictive.

In summary, with the electronic apparatus 100 according to the embodiment of the present disclosure, narrow beams that are different from and transmitted together with the communication beam are used as the sensing beams for sensing, so that the interferences of the sensing beams on the communication beam can be reduced while achieving the coverage of the sensing range. Furthermore, the sensing beams causing significant interferences to communication are removed by enhancement processing on the communication beam, and the removed sensing beams operate as the communication beam, further improving the communication performance. In addition, in a case that the present disclosure is applied to the JCR system, the performance of the sensing module is ensured.

### Second Embodiment

FIG. 8 is a block diagram showing functional modules of an electronic apparatus 200 according to another embodiment of the present disclosure. As shown in FIG. 8, the electronic apparatus 200 includes a transceiving unit 201 and a control unit 202. The transceiving unit 201 is configured to receive, from a communication transmitting terminal, a combined beam which includes a communication beam and a sensing beam subset, where each sensing beam subset includes one or more sensing beams within a sensing beam set respectively, each sensing beam within the sensing beam set is selected from the same beam codebook as the communication beam and the sensing beams are all different from the communication beam. The control unit 202 is configured to repeat the receiving until all sensing beams within the sensing beam set are traversed.

The transceiving unit 201 and the control unit 202 may be implemented by one or more processing circuitries, and the processing circuitry may be implemented as, for example, a chip or a processor. Moreover, it should be understood that various functional units in the electronic apparatus shown in FIG. 8 are only logical modules divided based on specific functions implemented by these functional units, and are not intended to limit a specific implementation.

The electronic apparatus 200 may be, for example, provided at a base station side, or may be communicatively connected to a base station. The base station described in the present disclosure may be a Transmit Receive Point (TRP), an Access Point (AP), or RSU. Here, it should be noted that the electronic apparatus 200 may be implemented in a chip level or in a device level. For example, the electronic apparatus 200 may operate as the base station itself, and may further include an external device such as a memory and a transceiver (not shown). The memory may be configured to store programs to be executed by the base station to implement various functions and related data information. The transceiver may include one or more communication interfaces to support communications with different apparatus (for example, UE, and another base station). The implementation of the transceiver is not limited herein. In addition, the electronic apparatus 200 may also be provided at a UE side. For example, in a scenario of the Internet of Vehicles, the electronic apparatus 200 may be provided at a vehicle side.

Similar to the first embodiment, the sensing beam set may include beams in the beam codebook other than the communication beam, thereby covering an entire angular domain. The beam codebook may be, for example, a DFT codebook.

In the embodiment, the electronic apparatus 200 is, for example, provided at the communication receiving terminal or communicatively connected to the communication receiving terminal. In order to distinguish different sensing beams, different sensing beams may carry different spreading sequence signals. For example, sensing beams that are adjacent in angle may carry spreading sequence signals with low cross-correlation. The transceiving unit 201 may further be configured to acquire, from the communication transmitting terminal in advance, a correspondence between the respective beams and the spreading sequence signals through predetermined signaling.

The setting of the sensing beams and the communication beam has been described in detail in the first embodiment, which is also applicable to this embodiment and are not repeated herein.

In addition, the control unit 202 may further be configured to determine an interference sensing beam based on receiving of the combined beam. The transceiving unit 201 provides information of the determined interference sensing beams to the communication transmitting terminal.

For example, the control unit 202 may be configured to estimate a beam gain of the communication beam and beam gains of the sensing beams based on a received signal, as described in the first embodiment with reference to equations (8) to (11). The control unit 202 may estimate the beam gain of the communication beam and the beam gains of the sensing beams by using least squares estimation or minimum mean square error estimation.

For example, the control unit 202 may determine a sensing beam with a beam gain above a predetermined threshold as the interference sensing beam. Here, the beam gain of the sensing beam may be a relative beam gain relative to the beam gain of the communication beam. As described in the first embodiment, the sensing beam with the relative beam gain above the predetermined threshold may be determined as the interference sensing beam. For example, in a case of |\tilde{q}_{s,i}|>qₜₕ, the sensing beam f_{s,i} is determined as the interference sensing beam.

Information of the interference sensing beams provided by the transceiving unit 201 may include beam indexes of one or more interference sensing beams. In addition, the information of the interference sensing beams may further include one or more of: the number of the interference sensing beams, and information of a beam gain of each of the interference sensing beams. The beam gain may be an absolute beam gain or the relative beam gain. The number of the interference sensing beams to be provided by the transceiving unit may be predetermined. In this case, the transceiving unit 201 may only provide some relevant information of a part of the determined interference sensing beams. In a case that the control unit 202 determines that there is no interference sensing beam, the transceiving unit 201 may not provide any feedback to the communication transmitting terminal.

The determination of the interference sensing beam and the provision of relevant information have been described in detail in the first embodiment, which are not repeated herein.

In summary, the electronic apparatus 200 according to the embodiment of the present disclosure receives the sensing beams that are different from and transmitted together with the communication beam, so as to determine the sensing beams causing significant interferences to communication. Furthermore, the electronic apparatus 200 provides feedback to the communication transmitting terminal, to enhance the communication beam, thereby improving the communication performance.

### Third Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

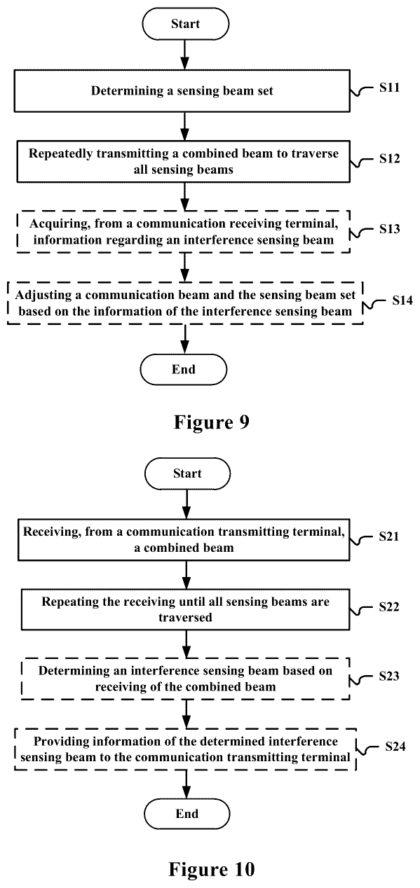

FIG. 9 is a flow chart of a method for wireless communications according to an embodiment of the present disclosure. As shown in FIG. 9, the method includes: determining a sensing beam set (S11), wherein, each sensing beam within the sensing beam set is selected from among the same beam codebook as a communication beam and the sensing beams are all different from the communication beam; and transmitting a combined beam and repeating the transmitting to traverse all sensing beams within the sensing beam set (S12), wherein, the combined beam comprises the communication beam and a sensing beam subset, and each sensing beam subset comprises one or more sensing beams within the sensing beam set respectively. The method may be performed on, for example, a UE side, such as a vehicle side in the scenario of the Internet of Vehicles. Alternatively, the method may be performed on a base station side, or RSU.

For example, the sensing beam set may include the beams in the beam codebook other than the communication beam. The number of the sensing beam subsets depends on, for example, a ratio of the number of the sensing beams within the sensing beam set to the number of beams that the communication transmitting terminal is capable of simultaneously forming.

In step S12, the combined beam corresponding to each sensing beam subsets can be sequentially transmitted in multiple REs. In order to distinguish different sensing beams, different sensing beams may carry different spreading sequence signals. The sensing beams that are adjacent in angle may carry spreading sequence signals with low cross-correlation. A correspondence between the respective beams and the spreading sequence signals can be further provided to the communication receiving terminal in advance through predetermined signaling. For example, in a case that the spreading sequence signal has a length L, and there are G sensing beam subsets, all sensing beams within the sensing beam set may be traversed on LG resource elements. Higher emission power may be allocated to the communication beam than that to the sensing beams.

As shown in the dashed line blocks in FIG. 9, the method may further include: acquiring, from a communication receiving terminal, information regarding interference sensing beams (S13), wherein, the interference sensing beam is determined by the communication receiving terminal based on receiving of the combined beam; and adjusting the communication beam and the sensing beam set based on the information of the interference sensing beams (S14).

For example, the interference sensing beam is a sensing beam determined by the communication receiving terminal to have a beam gain above a predetermined threshold. The beam gain may be a relative beam gain relative to the communication beam gain. The information of the interference sensing beams may include beam indexes of one or more interference sensing beams. In addition, the information of the interference sensing beams may further include one or more of: the number of the interference sensing beams, and information of a beam gain of each of the interference sensing beams.

The following adjustments may be performed in step S14: removing at least a part of the interference sensing beams from the sensing beam set, and adding the at least a part of the interference sensing beams to the communication beam, where the combined beam is transmitted using the adjusted communication beam and sensing beam set.

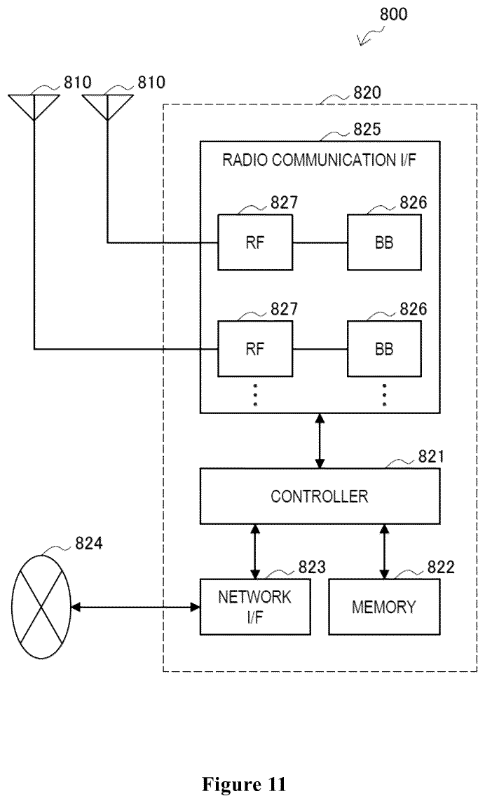

FIG. 10 is a flow chart of a method for wireless communications according to another embodiment of the present disclosure. As shown in FIG. 10, the method includes: receiving, from a communication transmitting terminal, a combined beam (S21) which includes a communication beam and a sensing beam subset, where each sensing beam subset includes one or more sensing beams within a sensing beam set respectively, each sensing beam within the sensing beam set is selected from among the same beam codebook as the communication beam and the sensing beams are all different from the communication beam; and repeating the receiving until all sensing beams within the sensing beam set are traversed (S22). The method may be performed on, for example, a base station side or RSU. Alternatively, the method is performed on a UE side, such as a vehicle side in the scenario of the Internet of Vehicles.

For example, the sensing beam set includes the beams in the beam codebook other than the communication beam. In order to distinguish different sensing beams, the sensing beams may carry different spreading sequence signals. Sensing beams that are adjacent in angle may carry spreading sequence signals with low cross-correlation. Although not shown in FIG. 10, the method may further include acquiring, from the communication transmitting terminal in advance, a correspondence between the respective beams and the spreading sequence signals through predetermined signaling.

In addition, as shown in dashed line blocks in FIG. 10, the method may further includes determining an interference sensing beam based on receiving of the combined beam (S23); and providing information of the determined interference sensing beams to the communication transmitting terminal (S24).

For example, in step S23, a beam gain of the communication beam and beam gains of the sensing beams are estimated based on a received signal. The beam gain of the communication beam and the beam gain of the sensing beam may be estimated by using least squares estimation or minimum mean square error estimation. For example, a sensing beam with a beam gain above a predetermined threshold may be determined as an interference sensing beam. The beam gain of the sensing beams may be a relative beam gain relative to the beam gain of the communication beam.

The information of the interference sensing beams described in step S24 may include beam indexes of one or more interference sensing beams. The information of the interference sensing beams may further include one or more of: the number of the interference sensing beams, and information of the beam gain of each of the interference sensing beams.

Note that the above methods may be used in combination with each other or separately, which have been described in detail in the first to second embodiments and are not repeated herein.

The technology of the present disclosure can be applied to various products.

For example, the electronic apparatus 100 and 200 may be implemented as various base stations. The base station may be implemented as any type of evolved Node B (eNB) or gNB (5G base station). An eNB includes, for example, a macro eNB and a small eNB. A small eNB may be an eNB that covers a cell smaller than a macro cell, such as a pico eNB, a micro eNB, and a home (femto) eNB. A similar situation may apply to the gNB. Alternatively, the base station may be implemented in any other type, such as a NodeB and a base transceiver station (BTS). The base station may include: a main body (also referred to as base station equipment) configured to control wireless communications; and one or more remote radio heads (RRHs) arranged at a different place from the main body. In addition, various UE may serve as a base station by temporarily or semi-permanently performing functions of the base station.

The electronic apparatus 100 and 200 may be implemented as various user equipments. The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). Furthermore, the user equipment may be a wireless communication module (such as an integrated circuit module including a single wafer) installed on each of the above-mentioned terminals.

### [Application Example Regarding a Base Station]

### First Application Example

FIG. 11 is a block diagram showing a first example of an exemplary configuration of an eNB or gNB to which technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via an RF cable.

Each of the antennas 810 includes a single or multiple antennal elements (such as multiple antenna elements included in a multiple-input multiple-output (MIMO) antenna), and is used for the base station apparatus 820 to transmit and receive wireless signals. As shown in FIG. 11, the eNB 800 may include the multiple antennas 810. For example, the multiple antennas 810 may be compatible with multiple frequency bands used by the eNB 800. Although FIG. 11 shows the example in which the eNB 800 includes the multiple antennas 810, the eNB 800 may also include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an S1 interface and an X2 interface). The network interface 823 may also be a wired communication interface or a wireless communication interface for wireless backhaul. If the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, Media Access Control (MAC), Radio Link Control (RLC), and a Packet Data Convergence Protocol (PDCP)). The BB processor 826 may have a part or all of the above-described logical functions instead of the controller 821. The BB processor 826 may be a memory storing communication control programs, or a module including a processor and a related circuit configured to execute the programs. Updating the program may allow the functions of the BB processor 826 to be changed. The module may be a card or a blade that is inserted into a slot of the base station apparatus 820. Alternatively, the module may also be a chip that is mounted on the card or the blade. Meanwhile, the RF circuit 827 may include, for example, a mixer, a filter, and an amplifier, and transmits and receives wireless signals via the antenna 810.

As shown in FIG. 11, the radio communication interface 825 may include the multiple BB processors 826. For example, the multiple BB processors 826 may be compatible with multiple frequency bands used by the eNB 800. The radio communication interface 825 may include multiple RF circuits 827, as shown in FIG. 11. For example, the multiple RF circuits 827 may be compatible with multiple antenna elements. Although FIG. 11 shows the example in which the radio communication interface 825 includes the multiple BB processors 826 and the multiple RF circuits 827, the radio communication interface 825 may also include a single BB processor 826 or a single RF circuit 827.

In the eNB 800 shown in FIG. 11, the transceiving unit 102 and the transceiver of the electronic apparatus 100, or the transceiving unit 201 and the transceiver of the electronic apparatus 200 may be implemented by the radio communication interface 825. At least a part of the functions may also be implemented by the controller 821. For example, the controller 821 may enhance the communication beam based on the sensing beams by performing the functions of the determination unit 101 and the transceiving unit 102, and may enhance the communication beam based on the sensing beams by performing the functions of the transceiving unit 201 and the control unit 202.

### Second Application Example

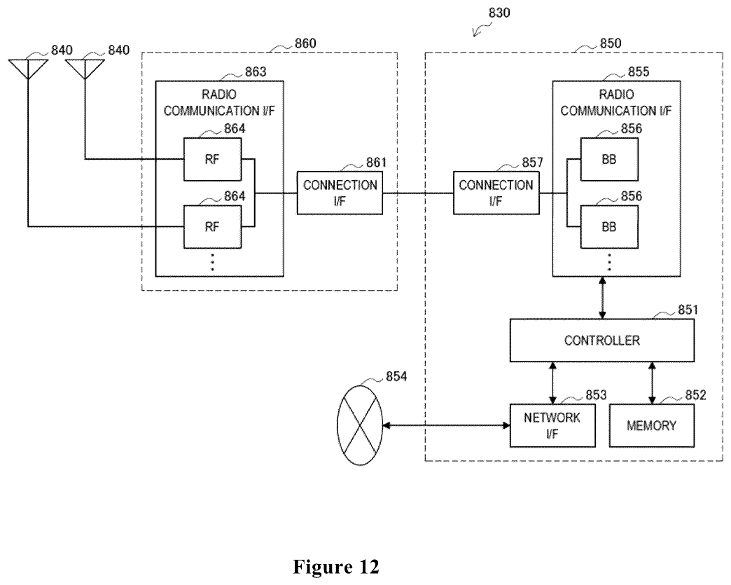

FIG. 12 is a block diagram showing a second example of the exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high velocity line such as an optical fiber cable.

Each of the antennas 840 includes a single or multiple antennal elements (such as multiple antenna elements included in an MIMO antenna), and is used for the RRH 860 to transmit and receive wireless signals. As shown in FIG. 12, the eNB 830 may include the multiple antennas 840. For example, the multiple antennas 840 may be compatible with multiple frequency bands used by the eNB 830. Although FIG. 12 shows the example in which the eNB 830 includes the multiple antennas 840, the eNB 830 may also include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 11.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 11, except that the BB processor 856 is connected to an RF circuit 864 of the RRH 860 via the connection interface 857. As show in FIG. 12, the radio communication interface 855 may include the multiple BB processors 856. For example, the multiple BB processors 856 may be compatible with multiple frequency bands used by the eNB 830. Although FIG. 12 shows the example in which the radio communication interface 855 includes the multiple BB processors 856, the radio communication interface 855 may also include a single BB processor 856.

The connection interface 857 is an interface for connecting the base station apparatus 850 (radio communication interface 855) to the RRH 860. The connection interface 857 may also be a communication module for communication in the above-described high velocity line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high velocity line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmits and receives wireless signals via the antenna 840. The radio communication interface 863 may include multiple RF circuits 864, as shown in FIG. 12. For example, the multiple RF circuits 864 may support multiple antenna elements. Although FIG. 12 shows the example in which the radio communication interface 863 includes the multiple RF circuits 864, the radio communication interface 863 may also include a single RF circuit 864.

In the eNB 830 shown in FIG. 12, the transceiving unit 102 and the transceiver of the electronic apparatus 100, or the transceiving unit 201 and the transceiver of the electronic apparatus 200 may be implemented by the radio communication interface 855 and/or the radio communication interface 863. At least a part of the functions may be implemented by the controller 851. For example, the controller 851 may enhance the communication beam based on the sensing beams by performing the functions of the determination unit 101 and the transceiving unit 102, and may enhance the communication beam based on the sensing beams by performing the functions of the transceiving unit 201 and the control unit 202.

### [Application Example Regarding User Equipment]

### First Application Example

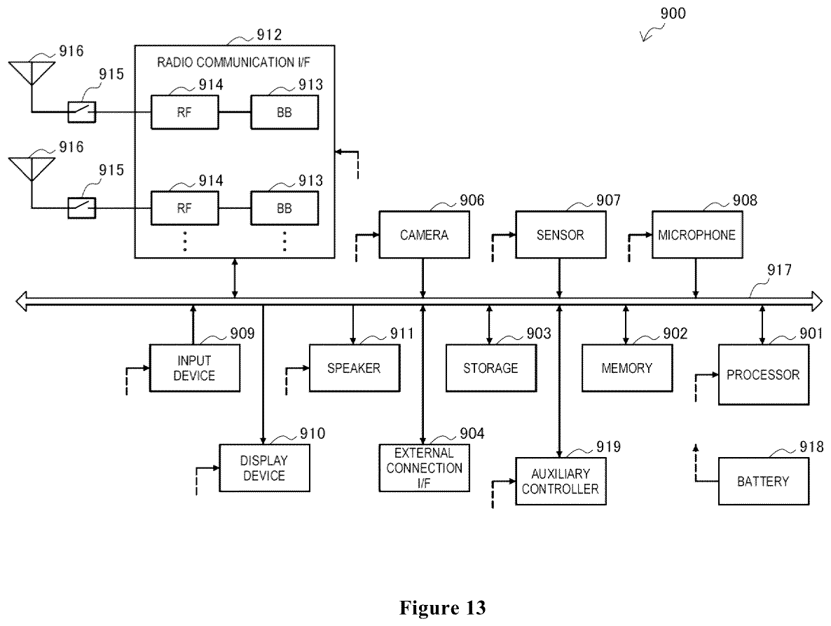

FIG. 13 is a block diagram showing an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disc. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds that are inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals that are outputted from the smartphone 900 to sounds.

The radio communication interface 912 supports any cellular communication scheme (such as LTE and LTE-advanced), and performs a wireless communication. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communications. The RF circuit 914 may include, for example, a mixer, a filter and an amplifier, and transmits and receives wireless signals via the antenna 916. It should be noted that although FIG. 13 shows a case that one RF link is connected to one antenna, which is only illustrative, and a case that one RF link is connected to multiple antennas through multiple phase shifters may also exist. The radio communication interface 912 may be a chip module having the BB processor 913 and the RF circuit 914 integrated thereon. The radio communication interface 912 may include multiple BB processors 913 and multiple RF circuits 914, as shown in FIG. 13. Although FIG. 13 shows the example in which the radio communication interface 912 includes the multiple BB processors 913 and the multiple RF circuits 914, the radio communication interface 912 may also include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a wireless local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. As shown in FIG. 13, the smartphone 900 may include the multiple antennas 916. Although FIG. 13 shows the example in which the smartphone 900 includes the multiple antennas 916, the smartphone 900 may also include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smart phone 900 shown in FIG. 13 via feeder lines that are partially shown as dashed lines in FIG. 13. The auxiliary controller 919 operates, for example, in a sleep mode to achieve a minimum necessary function of the smart phone 900.

In the smartphone 900 shown in FIG. 13, the transceiving unit 102 and the transceiver of the electronic apparatus 100, or the transceiving unit 201 and the transceiver of the electronic apparatus 200 may be implemented by the radio communication interface 912. At least a part of the functions may be implemented by the processor 901 or the auxiliary controller 919. For example, the processor 901 or the auxiliary controller 919 may enhance the communication beam based on the sensing beams by performing the functions of the determination unit 101 and the transceiving unit 102, and may enhance the communication beam based on the sensing beams by performing the functions of the transceiving unit 201 and the control unit 202.

### Second Application Example

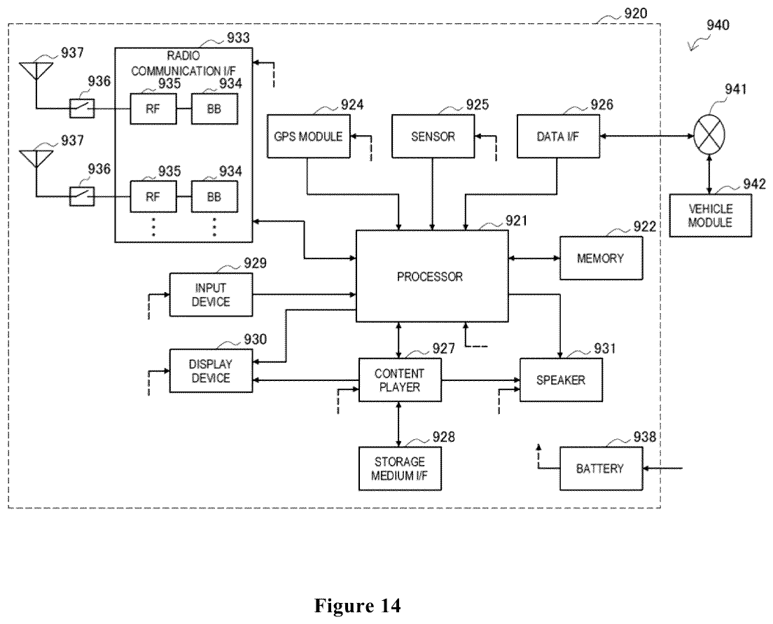

FIG. 14 is a block diagram showing an example of a schematic configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes a RAM and a ROM, and stores a program executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not shown, and acquires data (such as vehicle velocity data) generated by the vehicle.

The content player 927 reproduces content stored in a storage medium (such as a CD and a DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or content that is reproduced. The speaker 931 outputs a sound for the navigation function or the content that is reproduced.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communications. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as shown in FIG. 14. Although FIG. 14 shows the example in which the radio communication interface 933 includes the multiple BB processors 934 and the multiple RF circuits 935, the radio communication interface 933 may also include a single BB processor 934 or a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used for the radio communication interface 933 to transmit and receive wireless signals. As shown in FIG. 14, the car navigation apparatus 920 may include the multiple antennas 937. Although FIG. 14 shows the example in which the car navigation apparatus 920 includes the multiple antennas 937, the car navigation apparatus 920 may also include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to blocks of the car navigation apparatus 920 shown in FIG. 14 via feeder lines that are partially shown as dash lines in FIG. 14. The battery 938 accumulates power supplied from the vehicle.

In the car navigation apparatus 920 shown in FIG. 14, the transceiving unit 102 and the transceiver of the electronic apparatus 100, or the transceiving unit 201 and the transceiver of the electronic apparatus 200 may be implemented by the radio communication interface 933. At least a part of functions may be implemented by the processor 921. For example, the processor 921 may enhance the communication beam based on the sensing beams by performing the functions of the determination unit 101 and the transceiving unit 102, and may enhance the communication beam based on the sensing beams by performing the functions of the transceiving unit 201 and the control unit 202.

The technology of the present disclosure may also be implemented as an in-vehicle system (or a vehicle) 940 including one or more blocks of the car navigation apparatus 920, the in-vehicle network 941 and a vehicle module 942. The vehicle module 942 generates vehicle data (such as a vehicle velocity, an engine velocity, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

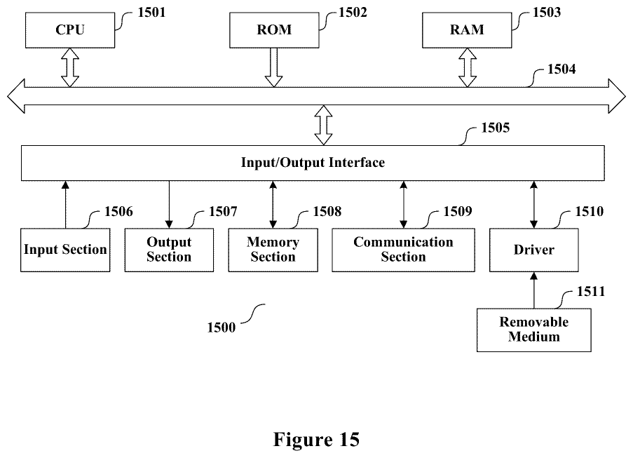

In the case where the present disclosure is realized with software or firmware, a program constituting the software is installed in a computer with a dedicated hardware structure (e.g. the general computer 1500 shown in FIG. 15) from a storage medium or network, wherein the computer is capable of implementing various functions when installed with various programs.

In FIG. 15, a central processing unit (CPU) 1501 executes various processing according to a program stored in a read-only memory (ROM) 1502 or a program loaded to a random access memory (RAM) 1503 from a memory section 1508. The data needed for the various processing of the CPU 1501 may be stored in the RAM 1503 as needed. The CPU 1501, the ROM 1502 and the RAM 1503 are linked with each other via a bus 1504. An input/output interface 1505 is also linked to the bus 1504.

The following components are linked to the input/output interface 1505: an input section 1506 (including keyboard, mouse and the like), an output section 1507 (including displays such as a cathode ray tube (CRT), a liquid crystal display (LCD), a loudspeaker and the like), a memory section 1508 (including hard disc and the like), and a communication section 1509 (including a network interface card such as a LAN card, modem and the like). The communication section 1509 performs communication processing via a network such as the Internet. A driver 1510 may also be linked to the input/output interface 1505, if needed. If needed, a removable medium 1511, for example, a magnetic disc, an optical disc, a magnetic optical disc, a semiconductor memory and the like, may be installed in the driver 1510, so that the computer program read therefrom is installed in the memory section 1508 as appropriate.

In the case where the foregoing series of processing is achieved through software, programs forming the software are installed from a network such as the Internet or a memory medium such as the removable medium 1511.

It should be appreciated by those skilled in the art that the memory medium is not limited to the removable medium 1511 shown in FIG. 15, which has program stored therein and is distributed separately from the apparatus so as to provide the programs to users. The removable medium 1511 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 1502 and the memory section 1508 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
at least one processor; and
at least one memory including computer program code, where the at least one memory and the computer program code are configured, with the at least one processor, to cause the electronic apparatus:
determine a sensing beam set, wherein, each sensing beam within the sensing beam set is selected from among the same beam codebook as a communication beam and the sensing beams are all different from the communication beam; and
transmit a combined beam and repeat the transmitting to traverse all sensing beams within the sensing beam set, wherein, the combined beam comprises the communication beam and a sensing beam subset, and each sensing beam subset comprises one or more sensing beams within the sensing beam set respectively.

2. The electronic apparatus according to claim 1, wherein the sensing beam set comprises a beam in the beam codebook other than the communication beam.

3. The electronic apparatus according to claim 1, wherein the at least one memory and the computer program code are configured, with the at least one processor, to cause the electronic apparatus to transmit the combined beam corresponding to each sensing beam subset in a plurality of resource elements sequentially.

4. The electronic apparatus according to claim 1, wherein the number of the sensing beam subset depends on a ratio of the number of the sensing beams within the sensing beam set to the number of beams that a communication transmitting terminal is capable of simultaneously forming.

5. The electronic apparatus according to claim 1, wherein the at least one memory and the computer program code are further configured, with the at least one processor, to cause the electronic apparatus to cause different sensing beams to carry different spreading sequence signals,
wherein sensing beams that are adjacent in angle carry spreading sequence signals with low cross-correlation.

6. (canceled)

7. The electronic apparatus according to claim 5, wherein, in a case that each of the spreading sequence signals has a length L, and there are G sensing beam subsets, the at least one memory and the computer program code are configured, with the at least one processor, to cause the electronic apparatus to traverse all sensing beams within the sensing beam set on LG resource elements.

8. The electronic apparatus according to claim 1, wherein the at least one memory and the computer program code are configured, with the at least one processor, to cause the electronic apparatus to allocate higher emission power to the communication beam than that to the sensing beam.

9. The electronic apparatus according to claim 5, wherein the at least one memory and the computer program code are configured, with the at least one processor, to cause the electronic apparatus to provide a correspondence between respective beams and the spreading sequence signals to a communication receiving terminal in advance through predetermined signaling.

10. The electronic apparatus according to claim 1, wherein the at least one memory and the computer program code are further configured, with the at least one processor, to cause the electronic apparatus to:
acquire, from a communication receiving terminal, information regarding interference sensing beams, wherein, the interference sensing beam is determined by the communication receiving terminal based on receiving of the combined beam; and
adjust the communication beam and the sensing beam set based on the information of the interference sensing beams.

11. The electronic apparatus according to claim 10, wherein the interference sensing beam is a sensing beam determined by the communication receiving terminal to have a beam gain above a predetermined threshold.

12. The electronic apparatus according to claim 11, wherein the beam gain is a relative beam gain relative to a communication beam gain.

13. The electronic apparatus according to claim 10, wherein the information of the interference sensing beams comprises beam indexes of one or more interference sensing beams.

14. The electronic apparatus according to claim 13, wherein the information of the interference sensing beams further comprises one or more of: the number of the interference sensing beams and information of a beam gain of each of the interference sensing beams.

15. The electronic apparatus according to claim 10, wherein the at least one memory and the computer program code are configured, with the at least one processor, to cause the electronic apparatus to:
perform the following adjustment: removing at least a part of the interference sensing beams from the sensing beam set, and adding the at least a part of the interference sensing beams to the communication beam, and
transmit the combined beam using the adjusted communication beam and sensing beam set.

16. The electronic apparatus according to claim 1, wherein the electronic apparatus is located at a vehicle side performing communication in an Internet of Vehicles.

17. An electronic apparatus for wireless communications, comprising:
at least one processor; and
at least one memory including computer program code, where the at least one memory and the computer program code are configured, with the at least one processor, to cause the electronic apparatus to:
receive, from a communication transmitting terminal, a combined beam which comprises a communication beam and a sensing beam subset, wherein each sensing beam subset comprises one or more sensing beams within a sensing beam set respectively, each sensing beam within the sensing beam set is selected from among the same beam codebook as the communication beam and the sensing beams are all different from the communication beam; and
repeat the receiving until all sensing beams within the sensing beam set are traversed.

18. The electronic apparatus according to claim 17, wherein the sensing beam set comprises beams in the beam codebook other than the communication beam,
wherein the sensing beams carry different spreading sequence signals, and
wherein sensing beams that are adjacent in angle carry spreading sequence signals with low cross-correlation.

19.-21. (canceled)

22. The electronic apparatus according to claim 17, wherein the at least one memory and the computer program code are further configured, with the at least one processor, to cause the electronic apparatus to:
determine an interference sensing beam based on receiving of the combined beam; and
provide information of the determined interference sensing beams to the communication transmitting terminal.

23. The electronic apparatus according to claim 22, wherein the at least one memory and the computer program code are further configured, with the at least one processor, to cause the electronic apparatus to:
estimate a beam gain of the communication beam and a beam gain of the sensing beam based on a received signal,
determine a sensing beam with a beam gain above a predetermined threshold as the interference sensing beam,
wherein the beam gain of the sensing beam is a relative beam gain relative to the beam gain of the communication beam,
wherein the information of the interference sensing beams comprises beam indexes of one or more interference sensing beams, and
wherein the information of the interference sensing beams further comprises one or more of the number of the interference sensing beams, and information of a beam gain of each of the interference sensing beams.

24.-29. (canceled)

30. A method for wireless communications, comprising:
determining a sensing beam set, wherein, each sensing beam within the sensing beam set is selected from among the same beam codebook as a communication beam and the sensing beams are all different from the communication beam; and
transmitting a combined beam and repeating the transmitting to traverse all sensing beams within the sensing beam set, wherein, the combined beam comprises the communication beam and a sensing beam subset, and each sensing beam subset comprises one or more sensing beams within the sensing beam set respectively.

31.-32. (canceled)
